(19) United States
(12) Patent Application Publication
(10) Pub. No.: US 2008/0224849 A1
(43) Pub. Date: Sep. 18, 2008

(54) MULTIFUNCTIONAL LIGHTING SYSTEM

(76) Inventor: Geno Sirhan, South San Francisco, CA (US)

Correspondence Address: TIPS GROUP;c/o Intellevate LLC, P. O. BOX 52050, Minneapolis, MN, 52050, US

(21) Appl. No.: 12/050,140

(22) Filed: Mar. 17, 2008

Related U.S. Application Data
(60) Provisional application No. 60/918,626, filed on Mar. 15, 2007.

(51) Int. Cl. G08B 19/00

(52) U.S. Cl. 340/521

(57) ABSTRACT

The teachings herein generally relate to a single unit, energy efficient, lighting and safety system and a security surveillance system that includes the lighting and safety system. The lighting and safety system that includes an enclosed housing having a lens, a fitting configured to connect to a standard receptacle, and a sensor that can be activated upon detection of sound, heat, or motion; an illumination source disposed within the housing and creating a maximum temperature of less than 70° C. in the atmosphere that is in contact with the illumination source; and a current control engine that is disposed within the housing and coupled to the sensor and illumination source to control current to the illumination source upon activation of the sensor.

### CROSS-REFERENCE TO RELATED APPLICATIONS

This application claims the benefit of U.S. Provisional Application No. 60/918,626 filed Mar. 15, 2007, which is hereby incorporated herein by reference in its entirety.

### BACKGROUND

1. Field of the Invention

The teachings herein generally relate to a single unit, energy efficient, lighting and safety system, and a security surveillance system that includes the lighting and safety system.

2. Description of the Related Art

For years, inefficient incandescent light bulbs have been used throughout households and businesses. Furthermore, rising energy costs and awareness of environmental hazard concerns are pushing governments, consumers, and businesses to look at innovative ways to reduce electrical consumption.

Many states are coming up with mandates and recommendations to save energy costs in both governmental and private buildings. Motion switches and sensors, for example, are known to save energy but have not been integrated into incandescent bulbs for a variety of reasons. Such reasons include the problems associated with the generation of extreme heat during the use of traditional systems. The substantial heat results in rapid failure of the components or the inability to incorporate certain components. As a result, the functionality contemplated for integration around the light bulb has not been effectively addressed.

For at least these reasons, traditional lighting sources have not been designed to incorporate circuitry and solid state electronics, such as motion switches and sensors, into the lighting unit itself, resulting in a single unit, self-contained system. Accordingly, the government, the industry, and the consumers have become reliant on existing processes and products.

With the ever-so-rapid increase in the cost of oil, along with the rising concern of the effects of global warming, solid state lighting, such as LED technology has become an attractive energy saving alternative. All users of lighting systems, systems of most any kind, will appreciate the integration of solid state lighting technology with other useful solid state technology to provide a product that can increase the efficiency, longevity, safety, and/or security of available lighting systems. An added benefit would be the development of a system that can be easily integrated into existing home fixtures and power supplies. Users will appreciate lighting systems that are easy to install, can be used with existing systems with little to no modification, and are a user-friendly, energy efficient product. The products taught herein can not only be designed to minimize energy consumption but can also be designed to maximize product life and provide intelligent lighting through added functionalities that can include, for example, processing power through a direct interface or network interface with a remote computer.

### SUMMARY OF THE INVENTION

The teachings provided herein are generally directed to a single unit, energy efficient, lighting and safety system. In some embodiments, the system includes an enclosed housing having a lens, a fitting, and a sensor. The fitting can be configured to connect to a standard receptacle, and the sensor can be activated upon detection of sound, heat, or motion. An illumination source can be disposed within the housing such that it creates a maximum operating temperature within the housing of less than 70° C. in the atmosphere that is in contact with the illumination source. In some embodiments, the illumination sources creates a maximum operating temperature within the housing of less than 40° C. A current control engine can be disposed within the housing and coupled to the sensor and illumination source to control current to the illumination source upon activation of the sensor.

In some embodiments, the standard receptacle is an E26 or E27 Edison socket. In some embodiments, the illumination source includes a light emitting diode, a compact fluorescent light, or a combination thereof. In some embodiments, the illumination source comprises a single high output light emitting diode. And, in some embodiments, the system comprises a cooling device to draw heat away from the illumination source.

In some embodiments, the system can include an instruction module embodied in a computer readable medium to activate the illumination source according to programmed instructions and a processor for executing modules in the computer readable medium. In some embodiments, the system can include an image storage module embodied in the computer readable medium; and a camera disposed within the housing for capturing images and providing the images to the image storage module. In these embodiments, the current control engine functions to control current to the camera upon activation of the sensor. In these embodiments, the system can include an instruction module embodied in a computer readable medium that is programmed to activate the camera upon activation of the sensor.

In some embodiments, the direction from which the sensor receives information is selected by positioning the housing. In some embodiments, the sensor and camera are not apparent to a passerby, allowing the system to function as a hidden security or surveillance system. In some embodiments, the system includes an interface disposed within the housing, allowing the camera to send images to a remote computer. In some embodiments, the sensor is coupled to an audible alarm for generating an audible tone after activation of the sensor. And, in some embodiments, the system includes a back-up power source.

In some embodiments, the single unit, energy efficient, lighting and safety system includes an enclosed housing having a lens, a fitting, and a sensor. In these embodiments, the fitting is configured to connect to a standard E26 or E27 Edison receptacle, and the sensor is activated upon detection of sound, heat, or motion. A solid state light source is disposed within the housing and creates a maximum operating temperature of less than 70° C. in the atmosphere that is in contact with the illumination source. In these embodiments, a current control engine is disposed within the housing and coupled to the sensor and illumination source to control current to the illumination source upon activation of the sensor. In some embodiments, the solid state light source comprises a single high output light emitting diode. In some embodiments, the system further comprises a cooling device to draw heat away from the solid state light source.

In some embodiments, the lighting system can be used in security and surveillance system. Such a system can include an enclosed housing having a lens, a fitting, and a sensor. In these embodiments, the fitting can be configured to connect to a standard receptacle, and the sensor can be activated upon detection of sound, heat, or motion. In some embodiments, the system includes an illumination source disposed within the housing and creating a maximum temperature of less than 70° C. and, in some embodiments, the illumination source creates a maximum temperature of less than 40° C., in the atmosphere that is in contact with the illumination source. The system can include an image storage module embodied in the computer readable medium; a camera disposed within the housing; a current control engine disposed within the housing and coupled to the sensor, illumination source, and camera to control current to the illumination and camera source upon activation of the sensor.

In some embodiments, the standard receptacle can be an E26 or E27 Edison socket. In some embodiments, the illumination source can include a light emitting diode, a compact fluorescent light, or a combination thereof.

In some embodiments, the system can include an instruction module embodied in a computer readable medium that is programmed to activate the camera upon activation of the sensor. In some embodiments, the sensor and camera are not apparent to a passerby, allowing the system to function as a hidden security or surveillance system. In some embodiments, the system includes an interface disposed within the housing, allowing the camera to send images to a remote computer. In some embodiments, the sensor can be coupled to an audible alarm for generating an audible tone after activation of the sensor. In some embodiments, the system can include a back-up power source.

### BRIEF DESCRIPTION OF THE DRAWINGS

FIG. 1 illustrates a motion activated light fixture that is currently on the market.

FIG. 2 illustrates a single unit, energy efficient, lighting and safety system, according to some embodiments.

FIGS. 3a through 3c illustrate examples of LED systems and configurations according to some embodiments.

FIG. 4 is a system block diagram according to some embodiments.

### DETAILED DESCRIPTION OF THE INVENTION

One of skill will appreciate that the teachings provided herein are generally directed to a single unit, energy efficient, lighting and safety system, and that several uses are possible for such a system, and these uses are not limited to the uses discussed above. One use for a single unit, energy efficient, lighting and safety system can be similar to the use for a motion activated light fixture that is currently on the market.

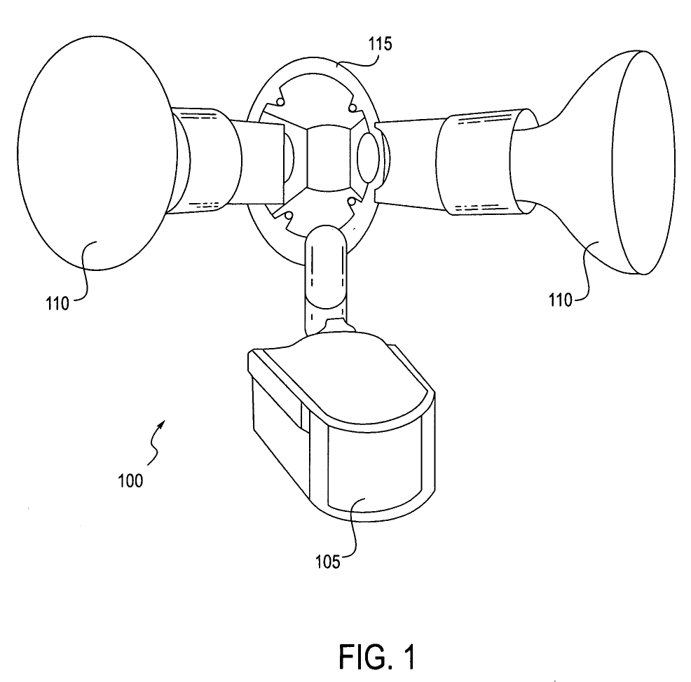

As described above, current light fixtures have much room for improvement. FIG. 1 illustrates a motion activated light fixture that is currently on the market. The light fixture 100 has a protruding external sensor 105 mounted between the two light bulbs 110. The sensor 105 is adjustable in position so that it can be aimed in various directions to detect motion when the fixture is mounted on the eaves or ceiling or on a wall. This current configuration of the light fixture 100 requires space considerations, and a modification to accommodate mounting plate 115 would be required where the power source is currently routed to a standard receptacle, such as an Edison screw-type receptacle. Moreover, because this external sensor protrudes from the fixture, it not only detracts from the appearance of the fixture and makes the system more cumbersome, but it also gives notice to an intruder that there is a motion detector attached to the light fixture.

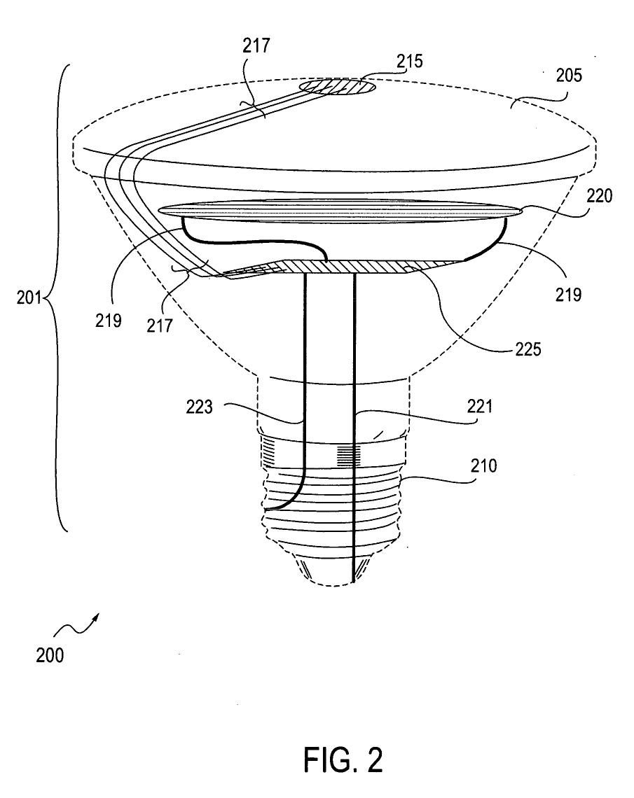

The teachings provided herein are directed to improved lighting systems that can provide improved energy efficiency, as well as safety and security to the user. FIG. 2 illustrates a single unit, energy efficient, lighting and safety system, according to some embodiments. The lighting system 200 comprises an enclosed housing 201 that includes a lens 205, a fitting 210, and a sensor 215. The fitting 210 can, in some embodiments, be configured to connect to a standard E26 receptacle. An illumination source 220 is disposed within the housing 201 and creates a maximum temperature of less than 70° C. in the atmosphere that is in contact with the illumination source 220. A current control engine 225 is disposed within the housing 201. The current control engine 225 is coupled to the sensor 215 and illumination source 220 using wires 217 and 219 to control current to the illumination source 220 upon activation of the sensor 215, where the current flows from the foot contact wire 221 to the base contact wire 223. The sensor 215 can, in some embodiments, be activated upon detection of sound, heat, and/or motion.

The system includes an enclosed housing having a lens, a fitting, and a sensor. The fitting can be configured to connect to a standard receptacle, and the sensor can be activated upon detection of sound, heat, or motion. The system can be configured to fit into any conventional light fixture, including indoor fixtures, outdoor fixtures, or both indoor and outdoor fixtures.

In some embodiments the system can be used for outdoor lighting such as, for example, to illuminate walkways, parking lots, roadways, building exteriors, landscape and architectural details; pole or stanchion mounted lights for uses in landscaping, roadways, and parking lots; pathway lighting, for example, which may be mounted at low levels for illuminating walkways; bollards, for example, for architectural outdoor lighting as a short, upright ground-mounted unit for cut-off type illumination used in egress lighting, walkways, steps, or other pathways; and high-bay/low-bay lighting for general lighting of industrial buildings, strip lights or industrial lights. In some embodiments, the system can include a free-standing or portable fixture, a recessed light, a ceiling-mounted version called a “downlight”, a troffer light, a surface-mounted light, a chandelier, a pendant light, a sconce, indirect lighting that may reflect off a ceiling for general illumination, a cove light, a track light fixture, an under-cabinet light, and the like. In some embodiments, the fixture may function as an accent light, a background light, a blacklight, a downlight, an emergency light, a flood light, a spotlight, a safelight, a safety lamp, a sconce, a searchlight, a security lighting, a step light, a street light, a strobe light, a spotlight, a torch lamp or torchiere for landscape or outdoor lighting, a nightlight, or perhaps a wallwasher light.

Those skilled in the art will appreciate that the housing can be any known material suitable for enclosing the system taught herein. In some embodiments, the housing 201 can include a metal or an alloy. In some embodiments, the alloys may include, for example, steel, brass, bronze or base metals such as iron, nickel, lead, copper, and zinc. In some embodiments, the alloys may include, for example, noble metals such as tantalum, platinum, and rhodium. In some embodiments, the housing can include wrought-iron or other ferrous and non ferrous metals. In some embodiments, the housing can include, for example, plastic, glass, composite glass/plastic, composite glass/metal, rubber. In some embodiments, the housing has components composed of glass. In some embodiments, the housing has components composed of a plastic or a plastic composite material.

It should be appreciated that the optical characteristics of the lens, controlled by the material selection, thickness, shape, coatings, and the like, can be designed by one of skill to achieve the desired transmission of the light emitted. Accordingly, one of skill will appreciate that the lens can also be any known material considered suitable for the desired optical characteristics. In some embodiments, the lens can be composed of a different material or combination of materials than the housing. In some embodiments, the lens can be of the same material as the housing. In some embodiments, the lens can be glass and, in some embodiments, the lens can be plastic. The lens can be modified using techniques known to one of skill, such as through the application of an optical coating to achieve desired light emission characteristics. For example, some LED lights can emit UV radiation, and some LED lights can be devoid of UV and IR radiation. In some embodiments, the lens can be composed of a hard glass, or quartz, doped with additives to block UV output. In some embodiments, the lens can include UV absorbing glass filters or some other coating containing a UV inhibitor in the lens. If UV output is desired, the lens can be made of an undoped quartz. In some embodiments, the lens can be quartz with an infrared-reflective coating or a multilayered dichroic coating.

The fitting can be configured to connect to any known receptacle. For example, in some embodiments the fitting can be configured to connect to candelabra receptacles E10, E11, or E12; and, in some embodiments, the fitting can be configured to connect to intermediate E17 or E14 receptacles. In some embodiments, the fitting can be configured to connect to mogul E39 or E40 receptacles, and in some embodiments, the fitting can be configured to connect to a medium E29 of perhaps the miniature E5 receptacle. In some embodiments, the fitting can be configured to connect to fluorescent sockets, HID sockets, incandescent sockets, par lamp sockets or quartz sockets. In some embodiments, the fitting can fit an E26 or E27 Edison socket. Accordingly, one of skill will appreciate that the system can include any fitting known to one of skill.

The sensor can include any motion detector known to one of skill. In some embodiments, the sensor can be a passive infrared sensor that uses a passive infrared network to sense infrared and produce an analog signal which is then passed through an amplifier to a signal controlled oscillator. The signal can then be converted into a digital signal to detect motion by a logic device. In some embodiments, the sensor can reflect ultrasonic energy or microwave energy off of an object to detect movement of the object. In some embodiments, a combination of sensors can be used for improved accuracy, which may be desired for systems having an alarm that creates an audible noise, for systems that send a signal through a network to a security service, or for systems that do both. In some embodiments, the sensor can include a combination of an infrared sensor and a microwave sensor. In some embodiments, other sensors may be incorporated, such as sensors that detect significant changes in sound or temperature.

The sensor can be positioned for optimal use, for example, to sense motion in one or more directions. In some embodiments, there is a single sensor contained in the system, and in some embodiments, there are a plurality of sensors contained in the system. In some embodiments, the direction from which the sensor receives information is selected by positioning the housing. In some embodiments, the sensor is not apparent to a passerby, allowing the system to function as a hidden security or surveillance system. In some embodiments, the sensor can be disposed on the outer surface of the lens and in contact with the lens, outside of the lens and detached from the surface of the lens, in the same plane as the lens, under the lens and in contact with the lens, under the lens and not in contact with the lens, or a combination thereof. In some embodiments, the sensor can be located as a part of the housing that does not compose the lens. In some embodiments, the sensor can be disposed, for example, anywhere within the housing, outside of the housing, or as part of the housing, as long as the sensor functions as intended and is part of a single unit system that can be installed into an existing standard receptacle without modifying the system or the receptacle.

An illumination source can be disposed within the housing such that it creates a maximum operating temperature of less than 80° C., less than 70° C., less than 60° C., less than 50° C., less than 40° C., or less than 30° C., in the atmosphere in the housing that is in contact with the illumination source. The illumination source can be a solid state lighting source utilizing light-emitting diodes, organic light-emitting diodes, polymer light-emitting diodes, or a combination thereof.

The term “LED” can refer to any system that is capable of receiving an electrical signal and producing a color of light in response to the signal. Thus, the term “LED” should be understood to include light emitting diodes of all types, light emitting polymers, semiconductor dies that produce light in response to current, organic LEDs, electro-luminescent strips, silicon based structures that emit light, and other such systems. In some embodiments, an “LED” may refer to a single light emitting diode package having multiple semiconductor dies that are individually controlled. It should also be understood that the term “LED” does not restrict the package type of the LED. The term “LED” includes packaged LEDs, non-packaged LEDs, surface mount LEDs, chip on board LEDs and LEDs of all other configurations. The term “LED” also includes LEDs packaged or associated with phosphor wherein the phosphor may convert energy from the LED to a different wavelength.

An LED system is one type of illumination source. The term “illumination source” can include all illumination sources, including LED systems, as well as incandescent sources, including filament lamps, pyro-luminescent sources, such as flames, candle-luminescent sources, such as gas mantles and carbon arch radiation sources, as well as photo-luminescent sources, including gaseous discharges, fluorescent sources, phosphorescence sources, lasers, electro-luminescent sources, such as electro-luminescent lamps, light emitting diodes, and cathode luminescent sources using electronic satiation, as well as miscellaneous luminescent sources including galvano-luminescent sources, crystallo-luminescent sources, kine-luminescent sources, thermo-luminescent sources, triboluminescent sources, sonoluminescent sources, and radioluminescent sources. Illumination sources may also include luminescent polymers capable of producing primary colors. The system design in which each of these illumination sources operate need to contain temperatures within ranges set-forth herein.

The term “illuminate” can refer to the production of a frequency of radiation by an illumination source with the intent to illuminate a space, environment, material, object, or other subject. The term “color” should be understood to refer to any frequency of radiation, or combination of different frequencies, within the visible light spectrum. The term “color,” as used herein, should also be understood to encompass frequencies in the infrared and ultraviolet areas of the spectrum, and in other areas of the electromagnetic spectrum where illumination sources may generate radiation.

LEDs come in multiple colors such as, for example, infra-red, red, orange, amber, yellow, green, turquoise, blue, cyan, and violet, because LEDs are monochromatic—a single LED may produce only a single color at a time. Different colors can be produced by mixing different LEDs having different colors, in some embodiments. White light, for example, can be produced by this color-mixing process, such as by combining red, blue, and green LEDs in the correct proportions. In fact, a white LED can also be composed of a single high-power LED, multiple white LEDs, or from LEDs of different colors that are mixed to produce white light.

LEDs can emit white light using a wavelength conversion through the assistance of an internal, light-converting phosphor. In some embodiments, the light is converted using a blue LED and a yellow phosphor, where the combination of the blue light with the yellow light emitted from the phosphor produces the desired color, such as a white light. In some embodiments, the light is converted using a blue LED and several phosphors, where the combination of the blue light and light of various colors is combined to produce the desired color of light, such as white light. In some embodiments, the light is converted using an ultraviolet LED and a combination of red, green, and blue phosphors, where the ultraviolet light excites the phosphors which are doped at measured amounts. In some embodiments, the light is converted using a blue Led and quantum dots, a process by which nanocrystal particles containing 33 or 34 pairs of atoms, primarily cadmium and selenium, are coated on the LED, where the blue light excites the quantum dots and converts the light into the desired color, such as a white light.

In some embodiments, phosphors are not used. In these embodiments, the desired color of light may be obtained by growing an LED on a homoepitaxial ZnSe substrate to simultaneously produce blue light from the active region and yellow light from the substrate. This embodiment provides an example of a system having a high efficiency LED.

The intensity of the light from an LED is roughly proportional to the amount of current supplied to the LED. In some embodiments, the LED is designed to operate at or around 20 milliamps. In some embodiments, the operating current is reduced to reduce the heat production and degradation of the LED. In some embodiments, the operating voltage is reduced to reduce the heat production and degradation of the LED. One of skill will appreciate the wide variety of power supplies and configurations available. In some embodiments, for example, one of skill may find it desirable to use a configuration that includes a voltage of 12 vDC, 24 vDC, or 120 vAC. In some embodiments, the LED can be a low voltage LED in that it uses a 12 vDC, 24 vDC or a 48 vDC power supply, as opposed to a 110/120 vAC power supply. In some embodiments, the LED is powered using a high voltage power supply, which may be, for example, a 110/120 vAC power supply. In some embodiments, the system includes a power supply/transformer/adaptor to convert the voltage to a lower voltage, such as 12 vDC, 24 vDC, or 48 vDC. In some embodiments, the fitting can be the type that adapts to the 220V system in Europe, for example, such as the common GU-10 connector.

The LED lights can be designed to use a lower amount of energy and, accordingly, generate a low amount of heat. In some embodiments, the system can operate in a wattage ranging from about 0.15 watts to about 15 watts, from about 0.5 watts to about 15 watts, from about 0.75 watts to about 15 watts, from about 1 watt to about 10 watts, from about 1 watt to about 7.5 watts, from about 1 watt to about 5.0 watts, from about 0.75 watts to about 5.0 watts, from about 0.75 watts to about 3.0 watts, from about 0.15 watts to about 0.75 watts, from about 0.15 watts to about 0.50 watts, from about 0.15 watts to about 0.35 watts, from about 0.25 watts to about 0.50 watts, or any range therein.

The view angle, or directivity, also known as directional pattern, of the LED can be selected by one of skill. In some embodiments, the view angle can range from about 4 to about 200 degrees, from about 8 to about 160 degrees, from about 20 to about 90 degrees, or any range therein. One of skill will appreciate that an almost endless variety of view angles are possible through selection of optics.

In some embodiments, the LED chip configuration is a single-chip configuration, a 6-chip configuration, a 7-LED cluster, a 3-LED cluster under a single lens, or a combination thereof. In some embodiments, for example, the systems taught herein can include a combination of configurations with a multi-switch, allowing the user to select a desired light emission shape and/or intensity.

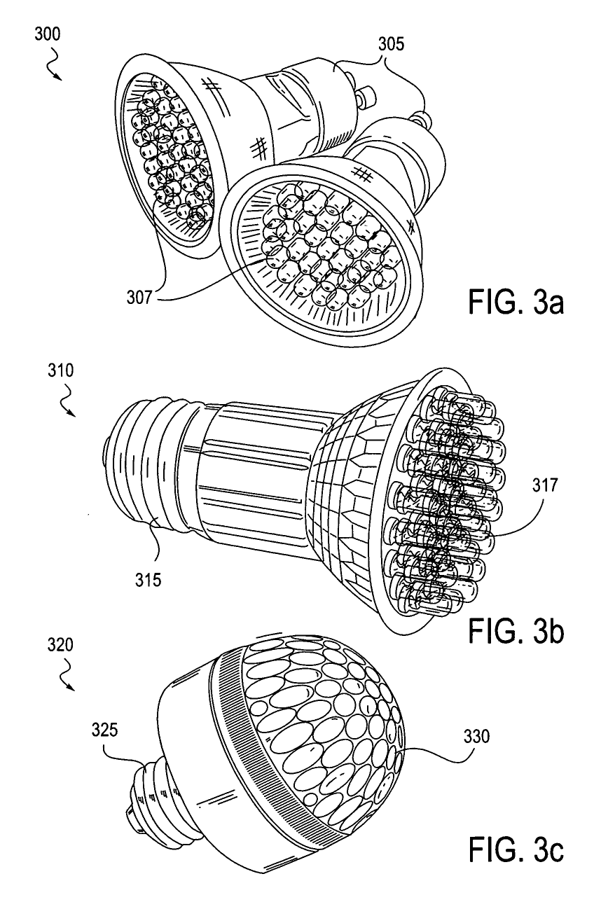

FIGS. 3a through 3c illustrate examples of LED systems and configurations according to some embodiments. Each of the systems in FIGS. 3a through 3c contain a similar configuration of components as described in FIG. 2, where variations of the component configurations and sizes would be apparent to one of skill. FIG. 3a illustrates an LED Lamp 300 having a GU10 twist lock fitting 305 and an enclosed LED lamp set 307, where this system can be used replace halogen reflector lamps. FIG. 3b illustrates an LED lamp 310 having an E27 Edison screw fitting 315 and an open LED lamp set 317. FIG. 3c illustrates a replacement LED light 320 for a household lamp having a standard Edison type fitting 325 and a lamp set under a dome lens 330 to provide the desired optical effect.

One of skill will appreciate that a virtually endless variety of geometrical shapes and sizes are possible in view of the teachings set forth herein and, accordingly, as functionalities are added to the systems described herein, the geometrical shapes of the systems and the volumes may need to be changed, increased, etc., in order to facilitate the addition of the components necessary to achieve the additional functionalities. Examples of functionalities can include the adding a camera, backup power source, memory modules, audible alarms, and the like, to the systems taught herein.

In some embodiments, the illumination source may be designed to include electrical filaments or gas. In some embodiments, the illumination source includes a solid state illumination source. In some embodiments, the illumination source is a light emitting diode, a compact fluorescent light, or a combination thereof. In some embodiments, the illumination source comprises a single high output light emitting diode. In most embodiments, the system should be designed to contain temperatures around the illumination source and current control engine as set-forth herein.

A current control engine can be designed to provide a processor and circuitry necessary to control current in the system. The current control engine can be disposed within the housing and coupled to the sensor and illumination source to control current to the illumination source upon activation of the sensor. One of skill will appreciate that, in some embodiments, the materials used in the formation of the current control engine 225 follow the JEDEC standard for solid state materials, which provides the temperature guidelines that should be met by the solid state materials. In some embodiments, the JEDEC standard temperature for the solid state materials ranges from about −40° C. to about 125° C. and can apply, for example, to the temperatures that the solid state materials should be able to withstand during a storage/standby mode. In some embodiments, the JEDEC standard temperature for the solid state materials ranges from about −40° C. to about 80° C., from about 0° C. to about 70° C., from about −55° C. to about 125° C., or any range therein, and can apply, for example, to the temperatures that the solid state materials should be able to withstand during operation.

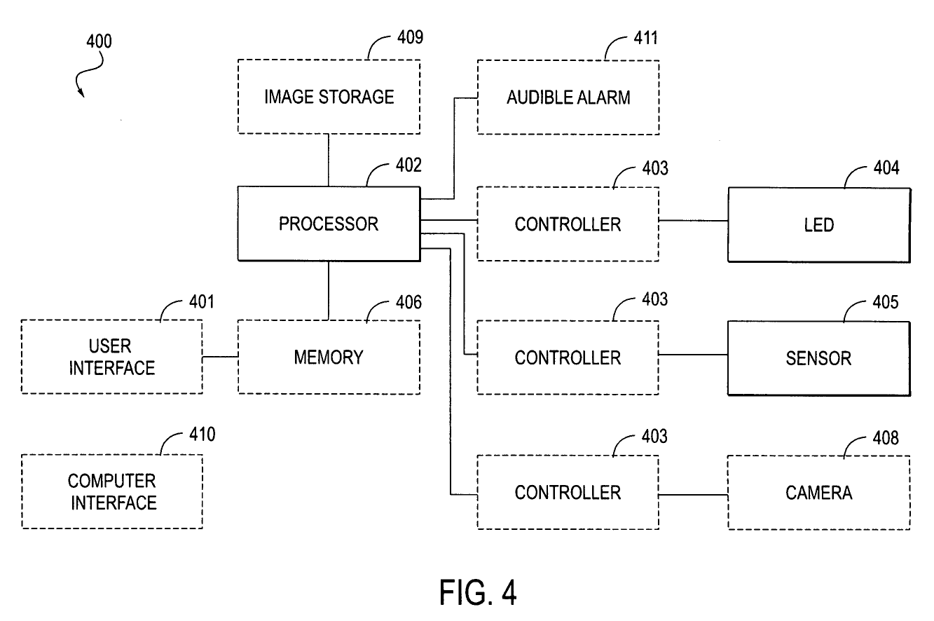

FIG. 4 is a system block diagram according to some embodiments. The system 400 may include a processor 402, a sensor 405, and an LED 404. In some embodiments, the system can optionally include a user interface 401 one or more controllers 403, one or more LEDs 404, and a memory 406. In some embodiments, the system can optionally include a camera 408 and an image storage module 409. In some embodiments, the system may include a computer interface 410 to communicate signals to a remote computer, either directly or through a network, to send information regarding malfunctions, motion, images, and/or act as an alarm. And, in some embodiments, the system can include an audible alarm 411. In general, the processor 402 may execute a program stored in the memory 406 to generate signals that control stimulation of the LED 404. The signals may be converted by the controllers 403 into a form suitable for driving the LED 404, which may include controlling the current, amplitude, duration, or waveform of the signals impressed on the LED 404, camera 408, and/or audible alarm 411.

The current control engine comprises a processor. The term processor may refer to any system for processing electronic signals. A processor may include a microprocessor, microcontroller, programmable digital signal processor or other programmable device, along with external memory such as read-only memory, programmable read-only memory, electronically erasable programmable read-only memory, random access memory, dynamic random access memory, double data rate random access memory, Rambus direct random access memory, flash memory, or any other volatile or non-volatile memory for storing program instructions, program data, and program output or other intermediate or final results.

A processor may also, or instead, include an application specific integrated circuit, a programmable gate array, programmable array logic, a programmable logic device, a digital signal processor, an analog-to-digital converter, a digital-to-analog converter, or any other device that may be configured to process electronic signals. In addition, a processor may include discrete circuitry such as passive or active analog components including resistors, capacitors, inductors, transistors, operational amplifiers, and so forth, as well as discrete digital components such as logic components, shift registers, latches, or any other separately packaged chip or other component for realizing a digital function. Any combination of the above circuits and components, whether packaged discretely, as a chip, as a chipset, or as a die, may be suitably adapted to use as a processor as described herein. Where a processor includes a programmable device, such as the microprocessor or microcontroller mentioned above, the processor may further include computer executable code that controls operation of the programmable device.

The controller 403 may be a pulse width modulator, pulse amplitude modulator, pulse displacement modulator, resistor ladder, current source, voltage source, voltage ladder, switch, transistor, voltage controller, or other controller. The controller 403 generally regulates the current, voltage and/or power through the LED, in response to signals received from the processor 402. In some embodiments, several LEDs 404 with different spectral outputs may be used. Each of these colors may be driven through separate controllers 403. The processor 402 and controller 403 may be incorporated into one device, such as in the sharing of a single semiconductor package. This device may drive several LEDs 404 in series where it has sufficient power output, or the device may drive single LEDs 404 with a corresponding number of outputs. By controlling the LEDs 404 independently, color mixing can be applied for the creation of lighting effects.

The memory 406 may store algorithms or control programs for controlling the LEDs 404. The memory 406 may also store look-up tables, calibration data, or other values associated with the control signals. The memory 406 may be a read-only memory, programmable memory, programmable read-only memory, electronically erasable programmable read-only memory, random access memory, dynamic random access memory, double data rate random access memory, Rambus direct random access memory, flash memory, or any other volatile or non-volatile memory for storing program instructions, program data, address information, and program output or other intermediate or final results. A program, for example, may store control signals to operate several different colored LEDs 404.

A user interface 401 may also be associated with the processor 402. The user may be located on the system directly, or on a remote computer, either directly or through a network interface. User interface 401 may be used to select a program from the memory 406, modify a program from the memory 406, modify a program parameter from the memory 406, select an external signal for control of the LEDs 404, initiate a program, or provide other user interface solutions. The processor 402 can be addressable to receive programming signals addressed to it.

The computer system, or remote computer, can have different architectures. For example, personal computers based on an Intel microprocessor often have multiple buses, one of which can be an I/O bus for the peripherals and one that directly connects the processor and the memory (often referred to as a memory bus). The buses are connected together through bridge components that perform any necessary translation due to differing bus protocols.

Network computers are another type of computer system that can be used. Network computers do not usually include a hard disk or other mass storage, and the executable programs are loaded from a network connection into the memory for execution by the processor. A Web TV system, which is known in the art, is also considered to be a computer system according to the present invention, but it may lack some of features, such as certain input or output devices. A typical computer system will usually include at least a processor, memory, and a bus coupling the memory to the processor.

In addition, the computer system can be controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in memory, including storing files on non-volatile storage media.

Depending on the configuration of the system and components, the amount of heat produced in the system can differ, and a means of cooling the system may be desirable. In some embodiments, a cooling device that extends the life of the system to a predetermined span may be a design consideration. Heat sinks, vents, and fans, and combinations thereof, are examples of cooling devices that can be part of a system design. In some embodiments, the system comprises a heat sink to draw heat away from the illumination source and/or the current control engine. The heat sink can be any heat sink known to one of skill, such as a natural convection heat sink that may be, for example, a stamped or extruded heat sink (available, for example, from Aavid Thermalloy, Concord, N.H.). In these embodiments, heat can be drawn away from the LED lights and circuitry, as well as away from the current control engine, to maintain the system at desired operating temperatures. An example of one type of heat sink can be found, for example, in U.S. Pat. No. 6,787,999.

In some embodiments, the cooling can be achieved using a forced cooling system, such as a forced air cooling system (available, for example, from Aavid Thermalloy, Concord, N.H.). In some embodiments, vents can be placed in preselected locations to keep components at a desired temperature, as taught herein. And, in some embodiments, any combination of two or more of a vent, a heat, and a fan may be used. One of skill will appreciate that, given the wide variety of system configurations available, there are a wide variety of thermal behaviors to be expected and, as such, the system cooling design will include a wide variety of heat sink, vent, and fan types, selections, and positions applicable to the teachings set-forth herein.

The design will usually include an analysis of thermal behavior, as well as a corresponding analysis of the JEDEC temperature standard, or other accepted industry standard, for the components used in the system. In some embodiments, cooling systems will be incorporated into the design when temperatures reach about 40° C. in the atmosphere in contact with a solid state component. In some embodiments, a cooling system will be incorporated into the design when temperatures reach about 50° C., about 60° C., about 70° C., or about 80° C. in the atmosphere in contact with a solid state component, where the use of a cooling system will depend upon system design factors that include system use (e.g. presence of shock, heat, vibration, etc.), failure, cost, and lifespan.

In some embodiments, the system can include an instruction module embodied in a computer readable medium to activate the illumination source according to programmed instructions and a processor for executing modules in the computer readable medium. In some embodiments, the system can include an image storage module embodied in the computer readable medium and a camera disposed within the housing for capturing images and providing the images to the image storage module. In these embodiments, the current control engine functions to control current to the camera upon activation of the sensor. In these embodiments, the system can include an instruction module embodied in a computer readable medium that is programmed to activate the camera upon activation of the sensor.

In some embodiments, the direction from which the sensor receives information is selected by positioning the housing. In some embodiments, the sensor and camera are not apparent to a passerby, allowing the system to function as a hidden security or surveillance system. In some embodiments, the system includes an interface disposed within the housing, allowing the camera to send images to a remote computer. In some embodiments, the sensor is coupled to an audible alarm for generating an audible tone after activation of the sensor.

The system can include a power source that is separate from the external power supply. In some embodiments, the system includes a back-up power source contained in the housing. In some embodiments, the backup power source can be used as a temporary source of power during power outages, for example. In some embodiments, the backup power source can be used to power solid state components for processing, separate from the external power source supplied to the system.

In some embodiments, the single unit, energy efficient, lighting and safety system includes an enclosed housing having a lens, a fitting, and a sensor. In these embodiments, the fitting is configured to connect to a standard E26 or E27 Edison receptacle, and the sensor is activated upon detection of sound, heat, or motion. A solid state light source is disposed within the housing and creates a maximum operating temperature of less than 70° C. in the air that is in contact with the light source. In these embodiments, a current control engine is disposed within the housing and coupled to the sensor and illumination source to control current to the illumination source upon activation of the sensor. In some embodiments, the solid state light source comprises a single high output light emitting diode. In some embodiments, the system further comprises a heat sink to draw heat away from the solid state light source.

In some embodiments, the lighting system can be used in a security and surveillance system. Such a system can include an enclosed housing having a lens, a fitting, and a sensor. In these embodiments, the fitting can be configured to connect to a standard receptacle, and the sensor can be activated upon detection of sound, heat, or motion. In some embodiments, the system includes an illumination source disposed within the housing and creating a maximum temperature within the housing of less than 70° C. and, in some embodiments, the illumination source creates a maximum temperature of less than 40° C. The system can include an image storage module embodied in the computer readable medium; a camera disposed within the housing; a current control engine disposed within the housing and coupled to the sensor, illumination source, and camera to control current to the illumination and camera source upon activation of the sensor.

One of skill will appreciate that many modifications and variations are possible for configurations, shapes and designs of the systems taught herein, and that the teachings provided are not intended to be limiting in any way. In some embodiments, taking into account the configuration, shape, and design of the system, the standard receptacle can be an E26 or E27 Edison socket, or any other standard receptacle. Likewise, in some embodiments, the illumination source can include a light emitting diode, a compact fluorescent light, or a combination thereof.

In some embodiments, the system can include an instruction module embodied in a computer readable medium that is programmed to activate the camera upon activation of the sensor. In some embodiments, the sensor and camera are not apparent to a passerby, allowing the system to function as a hidden security or surveillance system. In some embodiments, the system includes an interface disposed within the housing, allowing the camera to send images to a remote computer. In some embodiments, the sensor can be coupled to an audible alarm for generating an audible tone after activation of the sensor. In some embodiments, the system can include a back-up power source.

In some embodiments, the system may include an interface to a network, so that the network can send and receive signals related to instructing the system to operate in a desired way, or perhaps, to send information to a recipient, where the information could be the detection of a malfunction in the system, the detection of motion at the sensor, and/or an image from a camera. The information can function as a diagnostic, a collection of data to process regarding traffic analyses, population analyses, and the like, or the information can act as a silent arm as a security measure. One of skill will appreciate that signals can be transmitted using wireless technology or wired technology, depending on the design of interest to the user.

One of skill will appreciate that the teachings provided are merely exemplary and non-limiting. For example, it should be appreciated that the methods and apparatus presented herein are not inherently related to any particular materials or uses. Various general purpose systems and programs may be used in accordance with the teachings herein, or it may prove convenient to construct more specialized apparatus to perform the methods of some embodiments. Possible structures, methods, and systems that can be used for each of a variety of these systems can be derived by one of skill given the teachings herein. In addition, the techniques are not described with reference to any particular programming language and various embodiments may thus be implemented using a variety of programming languages. Accordingly, the terms and examples provided above are illustrative only and not intended to be limiting; and, the term “embodiment,” as used herein, means an embodiment that serves to illustrate by way of example and not limitation.

We claim:

1. A single unit, energy efficient, lighting and safety system, comprising:
An enclosed housing having a lens, a fitting, and a sensor, wherein the fitting is configured to connect to a standard receptacle, and the sensor is activated upon detection of sound, heat, or motion; and,
an illumination source disposed within the housing and creating a maximum operating temperature of less than 70° C. in the atmosphere that is in contact with the illumination source;
a current control engine disposed within the housing and coupled to the sensor and illumination source to control current to the illumination source upon activation of the sensor.

2. The system of claim 1, wherein the standard receptacle is an E26 or E27 Edison socket.

3. The system of claim 1, wherein the illumination source includes a light emitting diode.

4. The system of claim 1, wherein the illumination source includes a compact fluorescent light.

5. The system of claim 1, further comprising an instruction module embodied in a computer readable medium to activate the illumination source according to programmed instructions and a processor for executing modules in the computer readable medium.

6. The system of claim 1, further comprising:
an image storage module embodied in the computer readable medium; and
a camera disposed within the housing for capturing images and providing the images to the image storage module;
wherein, the current control engine functions to control current to the camera upon activation of the sensor.

7. The system of claim 6, further comprising an instruction module embodied in a computer readable medium that is programmed to activate the camera upon activation of the sensor.

8. The system of claim 6, wherein the direction from which the sensor receives information is selected by positioning the housing.

9. The system of claim 6, wherein the sensor and camera are not apparent to a passerby, allowing the system to function as a hidden security or surveillance system.

10. The system of claim 6, further comprising an interface disposed within the housing, allowing the camera to send images to a remote computer.

11. The system of claim 6, wherein the sensor is coupled to an audible alarm for generating an audible tone after activation of the sensor.

12. The system of claim 1, wherein the system includes a back-up power source.

13. The system of claim 1, wherein the illumination source creates a maximum operating temperature of less than 40° C. in the atmosphere that is in contact with the illumination source.

14. The system of claim 1, wherein the illumination source comprises a single high output light emitting diode.

15. The system of claim 1, wherein the system further comprises a cooling device to draw heat away from the illumination source.

16. A security and surveillance system, comprising:
an enclosed housing having a lens, a fitting, and a sensor, wherein the fitting is configured to connect to a standard receptacle, and the sensor is activated upon detection of sound, heat, or motion; and,
an illumination source disposed within the housing and creating a maximum operating temperature of less than 70° C. in the atmosphere that is in contact with the illumination source;
an image storage module embodied in the computer readable medium;
a camera disposed within the housing;
a current control engine disposed within the housing and coupled to the sensor, illumination source, and camera to control current to the illumination and camera source upon activation of the sensor.

17. The system of claim 16, wherein the standard receptacle is an E26 or E27 Edison socket.

18. The system of claim 16, wherein the illumination source includes a light emitting diode.

19. The system of claim 16, wherein the illumination source includes a compact fluorescent light.

20. The system of claim 16, further comprising an instruction module embodied in a computer readable medium that is programmed to activate the camera upon activation of the sensor.

21. The system of claim 16, wherein the sensor and camera are not apparent to a passerby, allowing the system to function as a hidden security or surveillance system.

22. The system of claim 16, further comprising an interface disposed within the housing, allowing the camera to send images to a remote computer.

23. The system of claim 16, wherein the sensor is coupled to an audible alarm for generating an audible tone after activation of the sensor.

24. The system of claim 16, wherein the system includes a back-up power source.

25. The system of claim 16, wherein the illumination source creates a maximum operating temperature of less than 40° C. in the atmosphere that is in contact with the illumination source.

26. A single unit, energy efficient, lighting and safety system, comprising:
An enclosed housing having a lens, a fitting, and a sensor, wherein the fitting is configured to connect to a standard E26 or E27 Edison receptacle, and the sensor is activated upon detection of sound, heat, or motion; and,
a solid state light source disposed within the housing and creating a maximum operating temperature of less than 40° C. in the atmosphere that is in contact with the illumination source;
a current control engine disposed within the housing and coupled to the sensor and illumination source to control current to the illumination source upon activation of the sensor.

27. The system of claim 24, wherein the solid state light source comprises a single high output light emitting diode.

28. The system of claim 24, wherein the system further comprises a cooling device to draw heat away from the solid state light source.
